(19) United States
(12) Patent Application Publication
(10) Pub. No.: US 2019/0259247 A1
(43) Pub. Date: Aug. 22, 2019

(54) VIDEO POKER GAME WITH MIRROR IMAGE WINS

(71) Applicant: Kathleen Nylund Jackson, Newport, NC (US)

(72) Inventor: Kathleen Nylund Jackson, Newport, NC (US)

(21) Appl. No.: 15/902,060

(22) Filed: Feb. 22, 2018

(51) Int. Cl. G07F 17/32

(52) U.S. Cl. CPC G07F 17/3293; G07F 17/3244

(57) ABSTRACT

A video poker machine is disclosed. A horizontal 5-card hand is dealt, and after a draw/replace step, the final hand is evaluated according to a paytable. If it is a winning hand, the horizontal placement of the elements that comprise the win is determined. Card #1 is in position #1, card #2 is in position #2, card #3 is in position #3, card #4 is in position #4, and card #5 is in position #5. A horizontal mirror image of the hand is then provided, wherein card #1 is now in position #5, card #2 is now in position #4, card #3 is now in position #3, card #4 is now in position #2, and card #5 is now in position #1. If the ranks of the winning elements of the final hand appear in the same positions in the mirror image hand, a bonus award is provided.

### RELATED APPLICATION DATA

This Application claims priority from U.S. Provisional Patent Application Ser. No. 62/601,173, filed Mar. 13, 2017, and having the Title VIDEO POKER GAME WITH MIRROR IMAGE WINS.

### BACKGROUND OF THE INVENTION

### 1. Field of the Invention

The present invention relates to a poker game suitable for use in casinos and other gaming establishments, as well as wagering or non-wagering space including websites and applications, as a video poker game. The invention further relates to casino gaming wherein a five-card draw poker game is played upon a video poker machine including a at least a processor, physical input device and monitor.

### 2. Background of the Art

Games based upon variations of poker have attained enormous popularity as casino-type entertainment games, particularly in the last twenty years. The success of poker games in the gaming industry is partially based on the game's simplicity (i.e., there is widespread public knowledge of the game rules) and the fact that players feel more directly involved in exercising judgment in the play of the game.

Traditional poker as played in card rooms, casinos, and wagering or non-wagering websites allows players to compete head to head against other players. The advent of video technology has also allowed poker games to be played not against other players but against a paytable that determines wins and losses. These games are described as “video poker”.

1

Most video poker games are a variant of draw poker. In basic draw poker, the player is dealt an initial array of cards. The player chooses to hold or keep none, one, some or all of the cards, the non-chosen cards are discarded, and replacement cards are provided for the discards. The final hand is then analyzed for winning combinations, and primary awards are provided for winning hands according to a predetermined paytable.

Since in virtually every gambling game there is a house advantage (that is, the casino will hold a percentage of the bet, and the player will play the game at less than a 100% payout), it is advantageous for the casino to provide games that attract players as well as entertain and keep them on the machine.

Certain attempts have been made to create new video poker games that offer bonus awards in addition to primary awards in order to stimulate player participation.

United States Patent Application No. 20020132657 (Matthiesen, et al.) describes a variation of draw poker that may be played either as a casino table game or as a video or computer game. The game is played with a single, conventional 52-card deck or with a computer simulation of such a deck. Basic rules are similar to traditional five-card draw poker and hands are traditionally ranked. The player may play a single hand, two hands, or specifically two hands that employ a mirror image feature. If the player elects to play two hands with the mirror image feature, the player is additionally paid for winning hands of the same rank. Hands are considered to be of the same rank if they have the same general nomenclature: i.e., one pair, two pairs, three of a kind, straight, flush, fill house, four of a kind, straight flush, and royal flush.

United States Patent Application No. 20120004021 (Shai-Hee) teaches a gaming system that includes a display; a symbol selector arranged to select a plurality of symbols for display at a plurality of display positions on the display; a display modifier arranged to modify the displayed symbols such that after modification of the symbols the locations of the symbols are a mirror image of the locations of the symbols before modification of the symbols; and an outcome evaluator arranged to determine whether symbol combinations defined by the displayed symbols after modification correspond to one or more winning outcomes.

United States Patent Application No. 20150364005 (Moody) describes a video poker game played on a video poker machine with a monitor that displays face-up a first hand including a plurality of cards. If the first hand satisfies a multiplier condition, a multiplier is randomly determined from a set of a plurality of different multipliers. The randomly-determined multiplier is associated with each active payline. Awards are determined based at least in part on any multiplier associated with said active payline. The multiplier condition is satisfied when the first hand includes a designated combination of cards, the first hand has a designated poker hand ranking, the first hand has one of a plurality of different designated poker hand rankings, or the first hand has a poker hand ranking of at least a designated value.

Each of the references discussed in this text art are incorporated herein in their entirety for all purposes.

It is an ever-increasing challenge to provide players with new and enticing gameplay features that will stimulate player interest and increase time on machine.

### SUMMARY OF THE INVENTION

A method of playing a wagering card game on a gaming device comprising at least a processer, a physical input device requiring the ability to receive at least a primary physical wager (at least paper tickets, paper money, coins, etc.) and a video monitor screen is disclosed. After the primary wager that is recognized by the processor is made, a hand of 5-card draw poker is dealt in a horizontally-disposed display from a standard deck of 52 cards. Card #1 is in position #1, card #2 is in position #2, card #3 is in position #3, card #4 is in position #4, and card #5 is in position #5. Each of the five cards in the hand represents an individual element. The player chooses to hold none, one, some or all of the dealt cards. Any non-held cards are discarded, and replacement cards from the remaining deck of 47 cards (52 minus the 5 dealt cards) are provided for the discards. The final hand is evaluated for any predetermined winning combinations of cards, and paid according to a predetermined paytable. If the final hand is a winning hand, and the player has preferably made an additional wager (along with the primary wager), the player may be awarded a bonus award in addition to or in lieu of the above payout.

After the final winning hand is evaluated, the processor then determines the horizontal placement of the elements that comprise the win. Again as described above, card #1 is position #1, card #2 is position #2, card #3 is position #3, card #4 is position #4, and card #5 is position #5. For example, in a win of Jacks or Better (4, King, 5, King, Queen), the processor determines the winning elements (King, King) are in horizontal positions #2 and #4. The processor then provides the mirror image of the hand by determining a horizontally-reversed mirror image, wherein the winning hand is displayed as: card #1 is now in position #5, card #2 is now in position #4, card #3 is now in position #3, card #4 is now in position #2, and card #5 is now in position #1. If the ranks of the winning elements of the final hand appear in the same positions in the mirror image hand, a bonus award is provided.

### BRIEF DESCRIPTION OF THE FIGURES

FIG. 1 shows a first video poker gaming device capable of executing the present invention.

FIG. 2 shows an example of a second device capable of executing the present invention.

FIG. 3 shows a graphic illustration of the eight possible special wins of the present technology.

FIG. 4 shows a first dealt hand of a first game of the present technology.

FIG. 5 shows the first hand at a hold/draw stage.

FIG. 6 shows the first hand of the first game at a final resolution stage.

FIG. 7 shows a dealt hand of a second game of the present technology.

FIG. 8 shows the dealt hand of the second game at the hold/draw stage.

FIGS. 9 through 11 show the dealt hand of the second game at a final resolution stage.

### DETAILED DESCRIPTION OF THE INVENTION

A method of playing an electronic video poker game uses one deck of 52 standard playing cards having 13 ranks (2, 3, 4, 5, 6, 7, 8, 9, 10, J, Q, K, A) and 4 suits (Hearts, Diamonds, Spades, Clubs). Alternately the deck may contain additional cards such as Jokers or Wild Cards. The game is played utilizing at least a processer, a physical input device requiring the ability to receive at least a primary physical wager (at least paper tickets, paper money, coins, etc.) and a video monitor screen. The game is preferably played on a video poker machine or casino gaming machine, but may also be played on a personal computer or pad, an internet gaming site, or as a mobile application.

The video poker game is basically a 5-card draw poker game, modified to include a bonus feature that provides an extra excitement and anticipation not seen in traditional draw poker. Alternately, the card game may be a 3-, 4-, 6-, or 7-card game. The game may consist of one hand of poker, or multiple hands of poker played simultaneously. The single-hand game begins with the processor recognizing a wager of physical cash or a physical item denoting credits and/or non-monetary points deposited into the physical input device in order to play the game. After the wager is recognized by the processor and thereby creating a credit balance, a hand of 5-card draw poker is dealt from a standard deck of 52 cards. The player chooses to hold none, some or all of the dealt cards. Any non-held cards are discarded, and replacement cards from the remaining deck of 47 cards are provided. The final hand is evaluated for any predetermined winning combinations of cards, and paid according to a predetermined paytable. If the final hand is a winning hand, and the player has preferably made an additional wager (along with the primary wager), the player may be awarded a bonus award in addition to or in lieu of the above payout.

The multiple-hand game begins with the processor recognizing a wager of cash, credits or non-monetary points in order to play each hand in the game. After the wager is made, thereby creating a credit balance, a hand of 5-card draw poker is dealt from a standard deck of 52 cards. The player chooses to hold none, some or all of the dealt cards. Any held cards are replicated in each wagered hand. Any non-held cards are discarded, and replacement cards from the remaining deck of 47 cards are provided for each wagered hand. The final hands are evaluated for any winning combinations of cards, and paid according to the above payout rules.

An extra wager in addition to the base wager may or may not be required in order to provide the bonus feature for the game. The present invention may require a base wager and an extra wager, wherein wins for the base wager are based on a first base predetermined paytable and wins for the extra wager are based on a second separate bonus predetermined paytable. Preferably the second paytable is based on multiples of the base paytable. Wins may be provided for the base wager only, the base wager and the extra wager, or the extra wager only.

In a preferred embodiment of the present invention, after a primary wager that is recognized by the processor is made and a credit balance therefore established, a hand of 5-card draw poker is dealt in a horizontally-disposed display from a standard deck of 52 cards. It is also contemplated that more or less cards may constitute the deck of cards. Card #1 is in position #1, card #2 is in position #2, card #3 is in position #3, card #4 is in position #4, and card #5 is in position #5. Each of the five cards in the hand represents an individual element. The player chooses to hold none, one, some or all of the dealt cards. Any non-held cards are discarded, and replacement cards from the remaining deck of 47 cards (52 minus the 5 dealt cards) are provided for the discards. The final hand is evaluated for any predetermined winning combinations of cards and paid according to the first predetermined paytable. If the final hand is a winning hand, and the player has preferably has initially made an additional wager (along with the primary wager), the player may be awarded a bonus award.

After the final winning hand is determined, the processor then determines the horizontal placement display of the elements that comprise the win. Only the ranks of the winning elements are considered. Card #1 is in position #1, card #2 is in position #2, card #3 is in position #3, card #4 is in position #4, and card #5 is in position #5. For example, in a final winning hand of Jacks or Better (4, King, 5, King, Queen), the processor determines the winning elements (King, King) are in horizontal positions #2 and #4. The processor then provides the mirror image of the hand by determining a horizontally-reversed image, wherein the winning hand is displayed as: card #1 is now in position #5, card #2 is now in position #4, card #3 is now in position #3, card #4 is now in position #2, and card #5 is now in position #1 (Queen, King, 5, King, 4). If the ranks of the winning elements of the final hand appear in the same positions in the mirror image hand, a bonus award is provided. In the preceding example, the two winning elements (the two Kings) are in position #2 and position #4 in both the final hand and the mirror-image displays, and so the bonus award would be provided.

In a first predetermined paytable that provides wins for Jacks or Better, Two Pair, 3-of-a-Kind, Straight, Flush, Full House, 4-of-a-Kind, Straight Flush, and Royal Flush, only Jacks or Better, Two Pair, 3-of-a-Kind, Full House, and 4-of-a-Kind would qualify to be potential bonus wins, since wins of Straights, Flushes, Straight Flushes and Royal Flushes cannot provide a winning mirror image.

To elaborate more fully, there are potentially eight mirror-image wins for a non-wild video poker game employing 52 cards (wherein X=elements of same rank, Z=elements of the same rank but different than X, and ? =any other element that is not an integral winning part of the winning hand). In a final hand win of Jacks or Better, both X,?,?,?,X and ?,X,?,X,? are mirror-image wins; in a final hand win of Two Pair, X,Z,?,Z,X is a mirror-image win; in a final hand win of 3-of-a-Kind, both X,?,X,?,X and ?,X,X,X,? are mirror-image wins; in a final hand win of Full House, both X,Z,Z,Z,X and Z,X,Z,X,Z are mirror-image wins; and in a final hand win of 4-of-a-Kind, X,X,?,X,X is mirror-image win.

It should be appreciated that a game variant such as Double Double Bonus may consider the fifth element (?) in a 4-of-a-Kind to be an integral element. For example, a final hand of A,A,3,A,A would consider the 3 as an integral element, since as a kicker for the four Aces it provides a larger win than just the four Aces. Also, in a video poker game with wild cards (for example, Deuces or Jokers), a wild card (W) may be considered as the card that it replaces, or as the wild card itself. For example, 5,5,3,W,5=5,5,3,5,5 may be considered a mirror win (5,W,3,5,5=5,5,3,5,5) if the wild card is considered to be a 5; if the wild card is considered a wild element only, then there would be no mirror win (wherein 5,5,3,W,5 and 5,W,3,5,5 are not mirror-image displays).

It is preferred that each mirror-image display win be a multiple of the corresponding base game payout; for example, the payout for a full house mirror image win is a multiple of the full house base game win. It is contemplated that all win payouts in the base game predetermined paytable may be multiplied by the same multiplier (i.e., all wins are ×5 pay) or by individually different multipliers (i.e., a Jacks or Better mirror-image win may be ×2, Two Pair may be 3×, 3-of-a-Kind may be 5× pay, etc.) to comprise the mirror-image predetermined paytable. It is also contemplated that a final mirror-image winning hand be paid first according to the base game predetermined paytable, and then paid according to the mirror-image predetermined paytable when the mirror-image of the winning hand is displayed; alternately, the final hand may receive only the mirror-image win amount.

In lieu of multiplier wins, each winning mirror-image final hand may be paid according to a credit-amount paytable. For instance, Jacks or Better may pay 10 credits, Two Pair may pay 15 credits, 3-of-a-Kind may pay 75 credits, Full House may pay 250 credits, and 4-of-a-Kind may pay 1199 credits.

It should be appreciated that the particular design and mathematical analysis of the game will dictate both the base predetermined paytable and the mirror-image win predetermined paytable.

Reference to the Figures will assist in further understanding of the practice of the present invention.

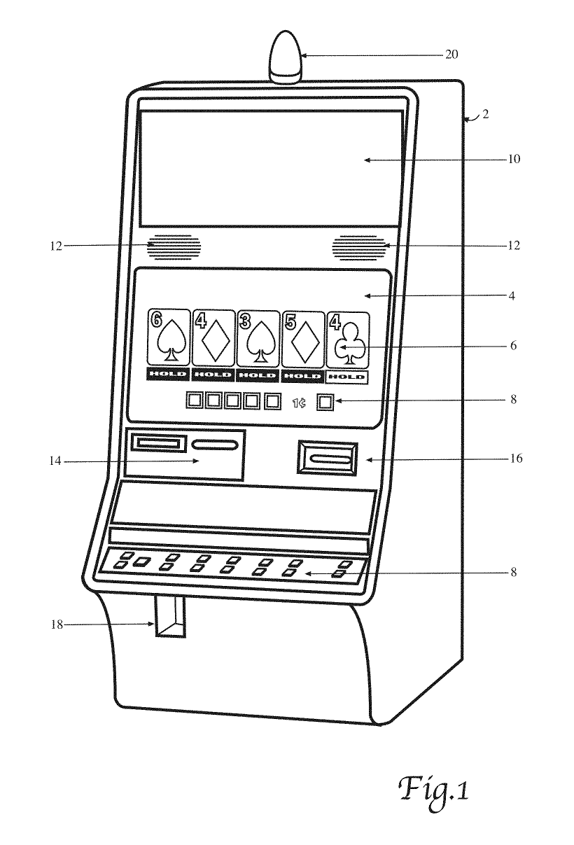

FIG. 1 illustrates a video poker gaming machine that includes at least a cabinet 2 and monitor screen 4 capable of displaying a video gambling game 6. The video gambling game comprises at least a symbol game and touchscreen buttons or physical buttons 8 that enable a player to play the video wagering game. An additional video monitor screen 10 may be provided, upon which individual game symbols may be displayed. The gaming machine or apparatus also includes speakers 12, and a physical value input/output device 14 that allows a player to insert a physical object that provides monetary value for game play and/or extracts monetary value of said game play. A separate device 16 is preferably provided that enables a player card or ticket to be inserted for the purpose of keeping track of player information, providing information of benefits or events, and the like. In rarer or older examples, a coin output device 18 may be provided. An electronic signaling device 20 may be apportioned on the top of the gaming machine to signal information of wins or needs to the appropriate people or employees.

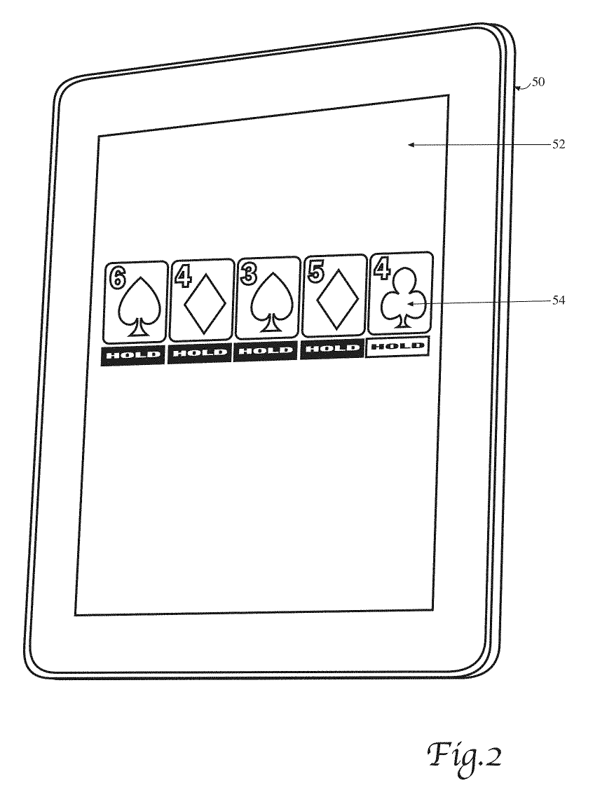

FIG. 2 illustrates an alternate device 50 capable of displaying and playing a video wagering game 54 on a screen monitor 52. The said devices may include at least a desktop computer, a laptop computer, an iPad®-like device, or an iPhone®-like device.

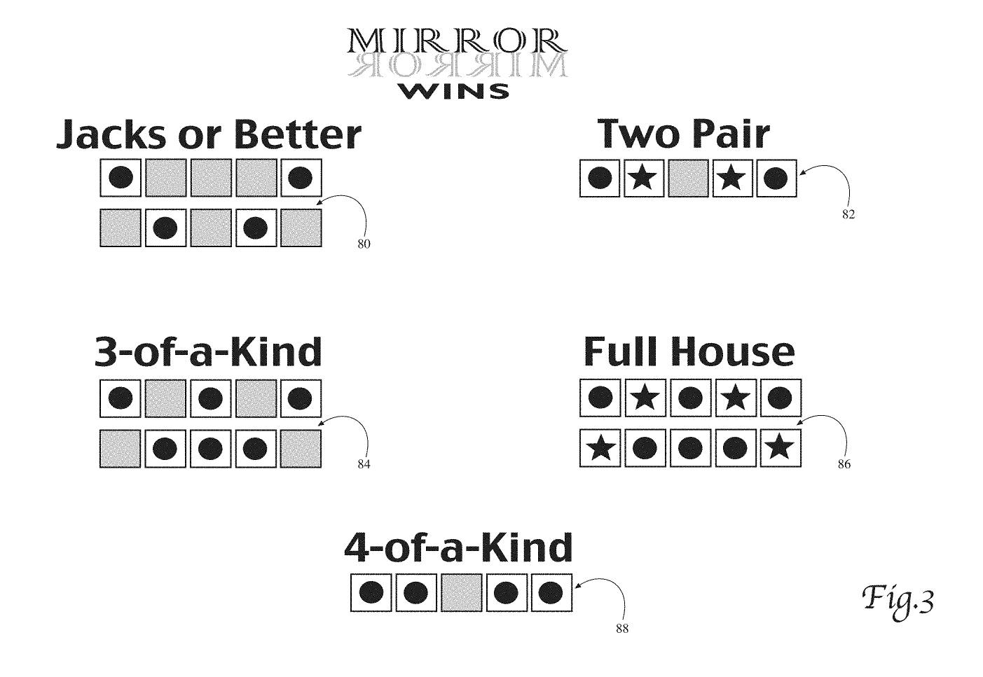

FIG. 3 is a graphic representation of the eight five-card final hand configurations that provide the special “Mirror Wins” bonus. In each representation, the cards are shown as squares, like-ranked cards as circles, differing like-ranked cards as stars, and grey areas as any cards that do not contribute to the winning aspect of the final hand. Shown are the two mirror-win hand configurations of Jacks or Better 80, the one mirror-win hand configuration of Two Pair 82, the two mirror-win hand configurations of 3-of-a-Kind 84, the two mirror-win hand configurations of Full House 86, and the one mirror-win hand configuration of 4-of-a-Kind 88.

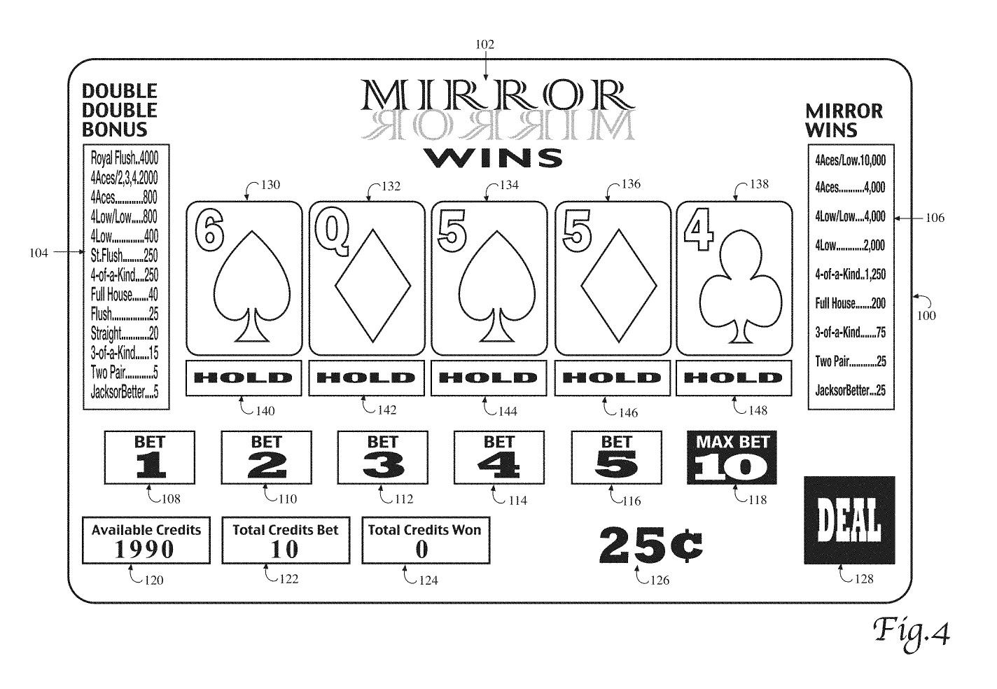

FIG. 4 illustrates an electronic screen 100 depicting the basic elements of a first hand of a first game of the present invention. The game's name (herein called “Mirror Wins”) 102, a first sample paytable for the base game of Double Double Bonus 104, and a second sample paytable for the special bonus Mirror Wins 106 are shown. Also shown are touchscreen buttons (108, 110, 112, 114, 116, 118) that enable the player to bet or wager by pressing the button (activated buttons are shown highlighted in black). It should be appreciated that any touchscreen buttons may in fact be physical buttons. Windows are shown that display the player's Available Credits 120, Total Credits Bet 122, and Total Credit Won 124. The denomination of the game 126 is shown; in this example, the player is playing a 250 game. A Deal button 128 is shown; the same button is utilized as a Draw button. In this example, the player has activated the Max Bet button 118, betting 10 credits ($2.50). The Total Credits Bet 122 (10 credits) is shown, as is the player's Available Credits 120 (1990 credits). He then has activated the Deal button 128, receiving the five cards of the initial hand: the 6 of Spades 130 in Card Position #1, the Queen of Diamonds 132 in Card Position #2, the 5 of Spades 134 in Card Position #3, the 5 of Diamonds 136 in Card Position #4, and the 4 of Clubs 138 in Card Position #5. Five Hold buttons (140, 142, 144, 146, 148) that correspond to the five dealt cards are also shown.

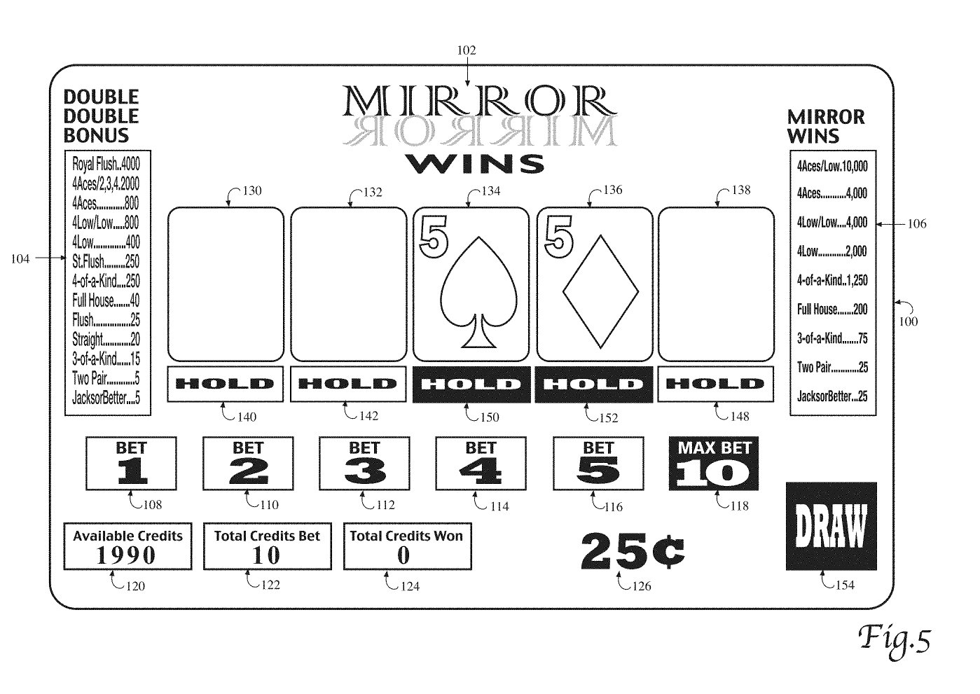

FIG. 5 refers to FIG. 4 wherein the player decides to hold the 5 of Spades 134 in Card Position #3 and the 5 of Diamonds 136 in Card Position #4 by activating the Hold buttons (150, 152) and then activating the Draw button 154. The three unheld cards (130, 132, 138) have been discarded.

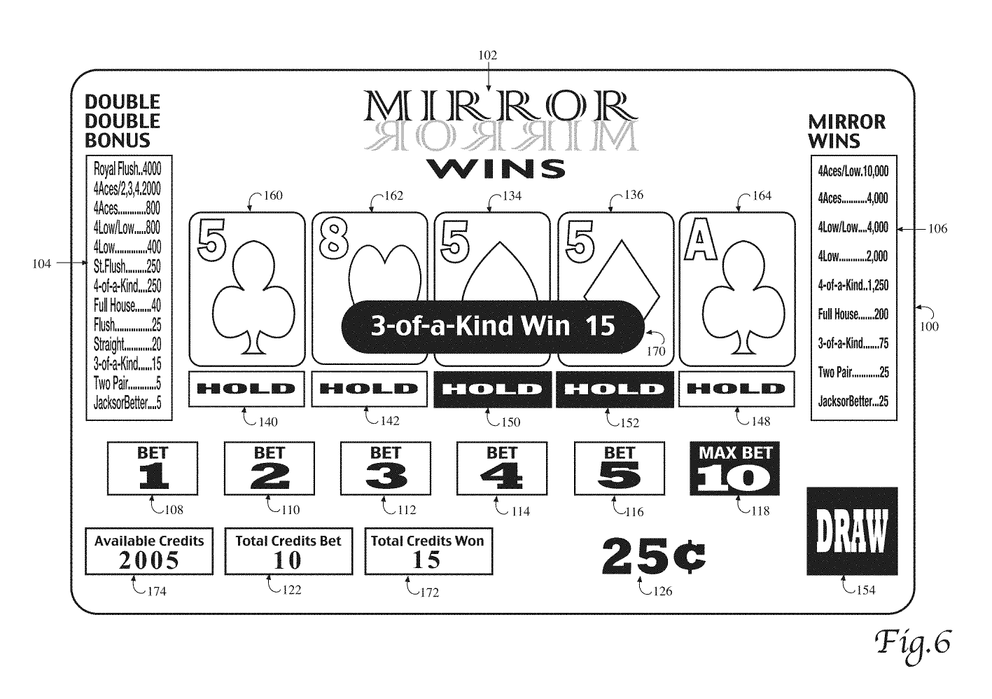

FIG. 6 refers to the elements in FIG. 5 with the discarded cards being replaced by the 5 of Clubs 160, the 8 of Hearts 162, and the Ace of Clubs 164. The final hand is evaluated for wins, and the player is then notified that he has achieved a 3-of-a-Kind win, as shown in the box 170. As per the first sample paytable 104, the Total Credits Won 172 are now shown as 15 credits, and the Available Credits 174 are now shown as 2005 credits. A mirror-win bonus is not provided since the configuration of the 3-of-a-Kind win is not one of the two 3-of-a-Kind hand configurations as shown in FIG. 3.

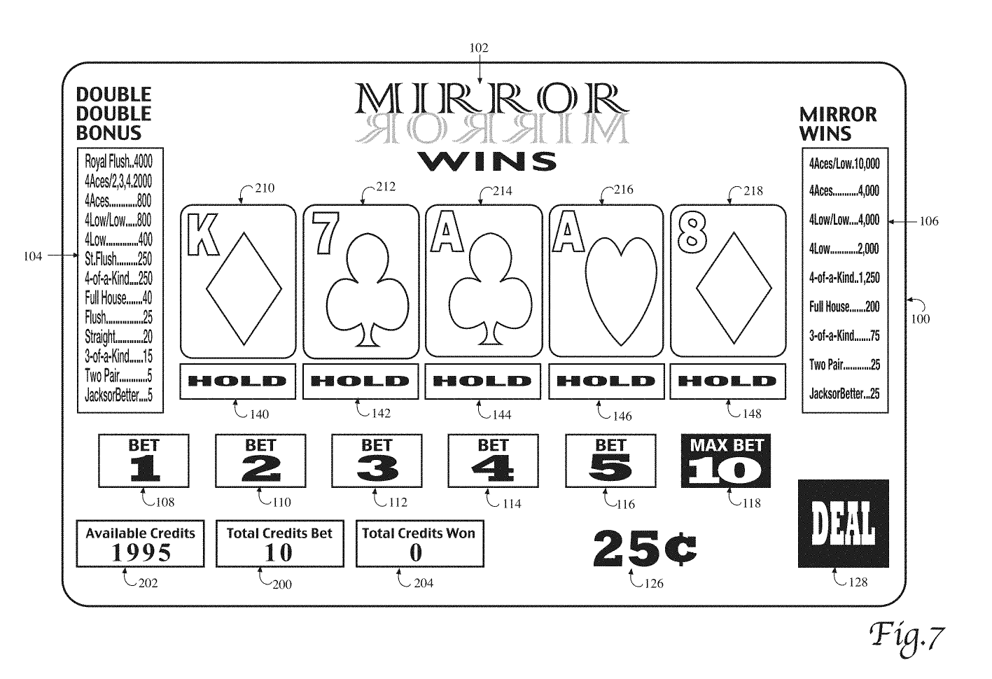

FIG. 7 shows a first hand of a second game of the present invention and refers to the basic gameplay elements as illustrated in FIG. 4. In this example, the player has activated the Max Bet button 118, betting 10 credits ($2.50). The Total Credits Bet 200 (10 credits) is shown, as is the player's Available Credits 202 (1995 credits) and Credits won 204. He then has activated the Deal button 128, receiving the five cards of the initial hand: the King of Diamonds 210, the 7 of Clubs 212, the Ace of Clubs 214, the Ace of Hearts 216, and the 8 of Diamonds 218.

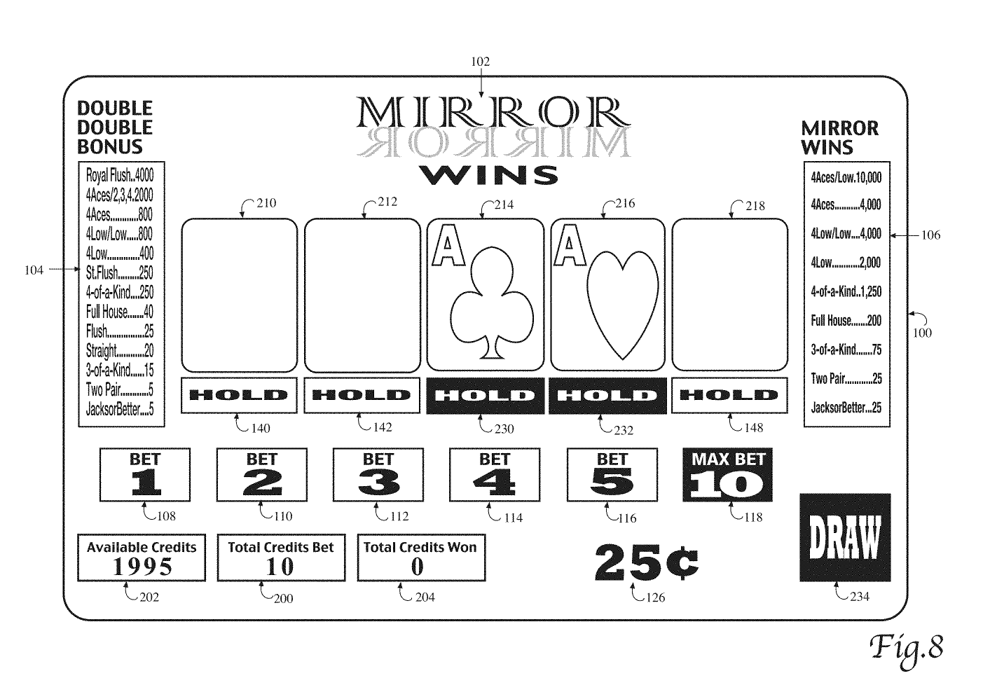

FIG. 8 refers to FIG. 7 wherein the player decides to hold the Ace of Clubs 214 and the Ace of Hearts 216 by activating the Hold buttons (230, 232) and then activating the Draw button 234. The three unheld cards (210, 212, 218) have been discarded.

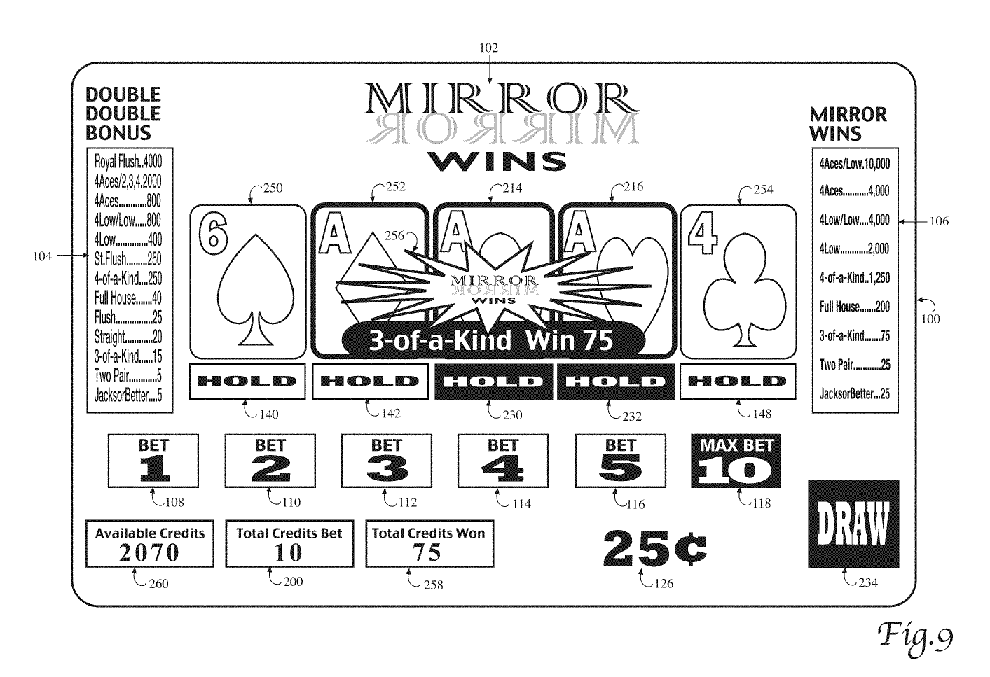

FIG. 9 refers to FIG. 8 with the discarded cards being replaced by the 6 of Spades 250, the Ace of Diamonds 252 and the 4 of Clubs 254. The final hand is evaluated for wins, and the player is then notified that he has achieved a mirror-wins 3-of-a-Kind win, as shown in the box 256. As per the second sample paytable 106, the Total Credits Won 258 are now shown as 75 credits, and the Available Credits 260 are now shown as 2070 credits. A mirror-win bonus is provided since the configuration of the 3-of-a-Kind win is one of the two 3-of-a-Kind hand configurations as shown in FIG. 3.

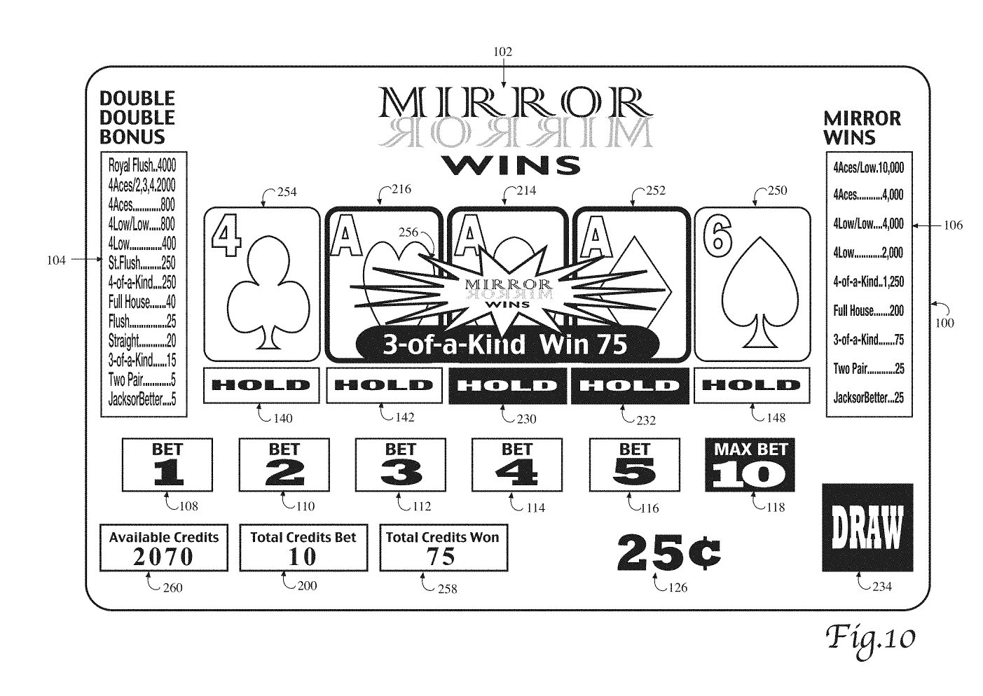

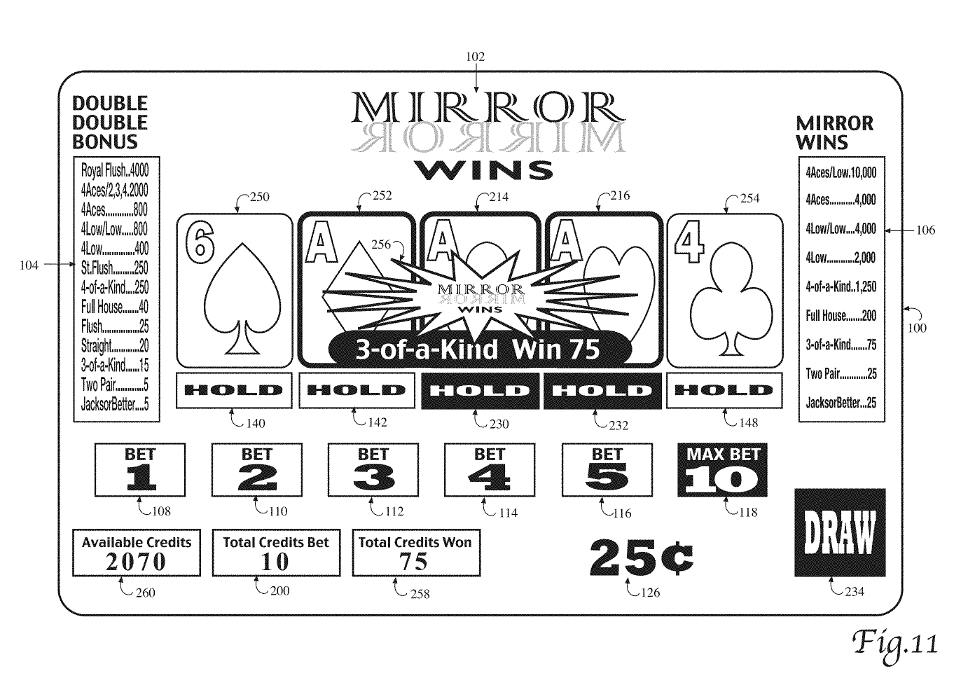

FIG. 10 shows the Mirror Win by providing the mirror image of the winning hand (switching the five card to read as the 4 of Clubs, the Ace of Hearts, the Ace of Clubs, the Ace of Diamonds and the 6 of Spades). Since the winning elements of the final hand (the 3 Aces) appear in the same card positions (#2, #3, and #4), the hand is paid according to the Mirror Wins paytable 106. The screen then reverts back to the original final hand as shown in FIG. 11.

Although specific examples and specific paytables have been provided in this discussion, these specifics are intended to be only support for the generic concepts of the invention and are not intended to be absolute limits in the scope of the technology discussed.

What is claimed:

1. A video poker machine comprising: a housing; at least one display device; at least one processor; at least one physical input device configured to detect a physical item associated with a monetary amount that establishes a credit balance; at least an electronic input device; and at least one memory device which stores a plurality of instructions which, when executed by the at least one processor, cause the at least one processor to operate with the at least one display device and the at least one electronic input device to:
a) establish a first predetermined paytable based on standard poker hand rankings associated with a final five-card poker hand ranking;
b) determine the cards that comprise the winning elements of the final five-card hand;
c) establish a second predetermined paytable based on the winning elements of the final five-card hand;
d) establish an initial deck of playing cards to be used in the play of the poker game;
e) enable a player, using the at least one electronic input device, to make a wager on a horizontally-disposed five-card poker hand, thereby decrementing the credit balance by the amount of the wager;
f) display to the player five randomly-dealt cards face up representing an initial poker hand;
g) establish a depleted deck of playing cards representing the initial deck of playing cards less the five cards of the initial poker hand;
h) enable the player, using the at least one electronic input device, to select none, one, a plurality or all of the face up cards from the initial poker hand as cards to be held;
i) discard from the initial poker hand each card that was not held;
13
j) randomly provide replacement cards from the depleted deck to complete a final five-card poker hand;
k) determine the poker hand ranking of the final poker hand;
l) determine the ranks of the winning elements in a final winning hand;
m) provide a horizontally-disposed mirror image of the final winning hand;
n) determine the ranks of the winning elements in the mirror image hand;
o) determine if the horizontally-disposed position of the ranks of the winning elements in the final hand and the mirror image hand are the same;
p) provide an award based on either the first paytable and/or the second paytable; and
q) initiate a payout associated with the credit balance after an actuation of a cashout button is received.

2. The video poker machine of claim 1 wherein an award is based on the first paytable if the final poker hand is a winning hand according to the first paytable.

3. The video poker machine of claim 1 wherein an award is based on the second paytable if the mirror image poker hand is a winning hand according to the second paytable.

4. The video poker machine of claim 1 wherein the horizontally-disposed cards of the final hand are as follows: card #1 is in position #1, card #2 is in position #2, card #3 is in position #3, card #4 is in position #4, card #5 is in position #5.

5. The video poker machine of claim 1 wherein the horizontally-disposed cards of the final mirror image hand are as follows: card #1 is in position #5, card #2 is in position #4, card #3 is in position #3, card #4 is in position #2, card #5 is in position #1.

6. The video poker machine of claim 5 wherein there are exactly eight configurations of mirror image winning hands.

7. The video poker machine of claim 6 wherein there are exactly two mirror image winning hands of Jacks or Better.

8. The video poker machine of claim 7 wherein the winning elements of the first mirror image winning hand appear exactly only in card positions #1 and #5, and wherein the winning elements of the second mirror image winning hand appear exactly only in card positions #2 and #4.

9. The video poker machine of claim 6 wherein there is exactly one mirror image winning hand of Two Pair.

10. The video poker machine of claim 9 wherein the winning elements of the mirror image winning hand appear exactly only in card positions #1, #2, #4 and #5, wherein the first Pair appears exactly only in card positions #1 and #5, and wherein the second Pair appears exactly only in card positions #2 and #4.

11. The video poker machine of claim 6 wherein there are exactly two mirror image winning hands of 3-of-a-Kind.

12. The video poker machine of claim 11 wherein the winning elements of the first mirror image winning hand appear exactly only in card positions #1, #3, and #5, and wherein the winning elements of the second mirror image winning hand appear exactly only in card positions #2, #3 and #4.

13. The video poker machine of claim 6 wherein there is exactly two mirror image winning hands of Full House.

14. The video poker machine of claim 13 wherein the Pair portion of the first mirror image winning hand of the Full House appears exactly only in card positions #1 and #5 with the 3-of-a-Kind portion of the Full House appearing exactly only in card positions #2, #3 and #4, and wherein the Pair portion of the second mirror image winning hand of the Full House appears exactly only in card positions #2 and #4 with the 3-of-a-Kind portion of the Full House appearing exactly only in card positions #1, #3 and #5.

15. The video poker machine of claim 6 wherein there is exactly one mirror image winning hand of 4-of-a-Kind.

16. The video poker machine of claim 15 wherein the winning elements of the mirror image winning hand appear exactly only in card positions #1, #2, #4 and #5.

17. The video poker machine of claim 1 wherein the poker hand may instead consist of three, four, six or seven cards.

18. The video poker machine of claim 1 wherein more than one poker hand may be played simultaneously.

19. The steps a) through q) of claim 1 wherein the plurality of instructions which, when executed by the at least one processor, cause the at least one processor to operate with the at least one display device and the at least one electronic input device on an electronic device.
